(19) United States
(12) Patent Application Publication
(10) Pub. No.: US 2009/0222323 A1
(43) Pub. Date: Sep. 3, 2009

(54) Opportunity segmentation

(76) Inventors: Laura Ann Figgie Kelly, Pleasanton, CA (US); Laurie Ann Dornberger, Boulder, CO (US)

Correspondence Address: Visa USA c/o Duane Morris LLP;Attn: James Sze, Esq., 101 West Broadway, Suite 900, San Diego, CA, 92101, US

(21) Appl. No.: 12/288,490

(22) Filed: Oct. 20, 2008

Related U.S. Application Data
(63) Continuation of application No. 12/074,252, filed on Feb. 29, 2008, now abandoned.

(51) Int. Cl. G06Q 10/00; G06Q 30/00; G06Q 40/00

(52) U.S. Cl. 705/10; 705/14

(57) ABSTRACT

A method to identify financial opportunity within a set of data, and maximize financial gains from the data set while minimizing marketing costs the method is presented. The method obtains the set of data, the set of data including a value component and an opportunity component, calculates a number of opportunity transactions. The method then creates a value matrix for value components and opportunity components of the set of data to define at least two audiences and identifies at least one audience of the at least two audiences that has a larger opportunity component than a smaller opportunity component of another of the at least two audiences. The method also performs marketing to the at least one of the at least two audiences that has the larger opportunity component.

### RELATED APPLICATIONS

This application claims priority to U.S. patent application Ser. No. 12/074,252, filed Feb. 29, 2008.

### FIELD OF THE INVENTION

Aspects of the invention relate to investment portfolios. More specifically, embodiments of the invention relate to identification and migration of funds, transactions and users to a payment method based upon user data of previous financial transactions.

### BACKGROUND INFORMATION

Payment methods for individuals and/or companies widely vary. These payment methods, moreover, each have their advantages and disadvantages. As each payment method has its individual advantages and disadvantages, use of the wrong payment method by an individual may have adverse economic consequences.

Individuals who use payment methods, such as for financial transaction cards, often do not know about payment options that are available to them as they have not been informed of advantages of the different payment methods.

Financial institutions may also maximize their financial gains from users by identifying users that have a high likelihood of using new products. Marketing efforts, for example, that are made to large numbers of individuals often require large amounts of capital. If only a small number of individuals actually use the products provided, then the marketing effort will result in less economic return for the institution due to the high cost of marketing.

### SUMMARY

In one embodiment, a method to identify financial opportunity within a set of data, and maximize financial gains from the data set while minimizing marketing costs is proposed. The method comprises obtaining the set of data, the set of data including a value component and an opportunity component. The method further calculates a number of opportunity transactions and creating a value matrix for value components and opportunity components of the set of data to define at least two audiences. The method identifies at least one audience of the at least two audiences that has a larger opportunity component than a smaller opportunity component of another of the at least two audiences. The method also provides for marketing to the at least one of the at least two audiences that has the larger opportunity component.

In another embodiment of the invention, the calculation of the number of opportunity transactions includes adding a number of checks written by an individual with a number of PIN transactions and a number of ATM withdrawals.

In another embodiment of the invention, the value component of the set is calculated from a number of financial signature transactions completed by an individual.

In a further embodiment of the invention, the opportunity component of the set is calculated from transactions that have a possibility of migration from a lower financial gain to a higher financial gain.

In another embodiment, the method is performed such that the set of data is derived from financial transaction card users. In a still further embodiment, the method is performed such that the calculation of the number of opportunity transactions includes adding a number of checks written by an individual with a number of PIN transactions and a number of ATM withdrawals minus a number of checks written that cannot be migrated.

In another embodiment, the identifying of the at least one audience of the at least two audiences that has a larger opportunity component than a smaller opportunity component of another of the at least two audiences is performed through dividing the data into a matrix defined by an average number of offline transactions per month and an average number of opportunity transactions per month. The method may also further comprise validating the audiences of the defined matrix. The validating of the audiences may use a mean variable distribution of the data.

The method may further comprise identifying at least one audience of the at least two audiences that has a larger opportunity component than a smaller opportunity component of another of the at least two audiences to a higher value opportunity. The method may further comprise tracking the value components and the opportunity components of all audiences.

In a further embodiment, a program storage device readable by machine, tangibly embodying a program of instructions executable by the machine to identify financial opportunity within a set of data, and maximize financial gains from the data set while minimizing marketing costs is presented. In this program storage device, the method performed comprises obtaining the set of data, the set of data including a value component and an opportunity component, calculating a number of opportunity transactions, creating a value matrix for value components and opportunity components of the set of data to define at least two audiences, identifying at least one audience of the at least two audiences that has a larger opportunity component than a smaller opportunity component of another of the at least two audiences, and marketing to the at least one of the at least two audiences that has the larger opportunity component.

The program storage device may also be configured such that the method accomplished by the device provides for the calculation of the number of opportunity transactions includes adding a number of checks written by an individual with a number of PIN transactions and a number of ATM withdrawals.

The program storage device may also be configured in another embodiment wherein in the method performed the value component of the set is calculated from a number of financial signature transactions completed by an individual. The program storage device may also be configured such that the opportunity component of the set is calculated from transactions that have a possibility of migration from a lower financial gain to a higher financial gain.

The program storage device may also be configured such that the method performs instructions wherein the set of data is derived from financial transaction card users.

The program storage device may also be configured such that the calculation of the number of opportunity transactions includes adding a number of checks written by an individual with a number of PIN transactions and a number of ATM withdrawals minus a number of checks written that cannot be migrated.

The program storage device may also be configured in another non-limiting embodiment, wherein the method performed provides for identifying at least one audience of the at least two audiences that has a larger opportunity component than a smaller opportunity component of another of the at least two audiences is performed through dividing the data into a matrix defined by an average number of offline transactions per month and an average number of opportunity transactions per month. The method may further comprise the step of validating the audiences of the defined matrix. The validating of the audiences may use a mean variable distribution of the data.

In a further embodiment, the program storage device may further comprise a method that provides for migrating at least one audience of the at least two audiences that has a larger opportunity component than a smaller opportunity component of another of the at least two audiences to a higher value opportunity.

### BRIEF DESCRIPTION OF THE DRAWINGS

FIG. 1 is a graphical representation of a segmentation process and anticipated migration of data per a segmentation process.

FIG. 2 is a segmentation matrix using average number of opportunity transactions and average amount of offline spend.

FIG. 3 is a mean variable distribution of data for a baseline set of data.

FIG. 4 is a mean variable distribution of data for a current set of data.

FIG. 5 is a mean variable distribution of data for a difference (current−baseline) set of data.

FIG. 6 is a process for marketing using opportunity segmentation.

FIG. 7 is an opportunity identification transaction for opportunity segmentation.

FIG. 8 is an audience definition matrix used to segment data of financial card users.

FIG. 9 is method to identify financial opportunity within a set of data, and maximize financial gains from the data set while minimizing marketing costs.

FIG. 10 is an audience distribution validation matrix.

FIG. 11 is a baseline−current and difference audience segmentation matrices based upon average number of checks written, average number of ATM withdrawals and PIN transactions conducted.

FIG. 12 is a audience migration matrix wherein a percentages of accounts that remain the same, the percentage of accounts moved to higher performing segments and a percentage of accounts moved to lower performing segments is provided.

FIG. 13 is a matrix of segments that were moved based upon activities of the audience.

FIG. 14 is a matrix of segments that were moved based upon the defined audience as broken down by PIN amount transactions, average off-line transaction amounts and average ATM transaction amounts.

FIG. 15 is a sample size calculation formula for no mail size for incremental spend.

FIG. 16 is a formula for no mail size for response/enroll rate.

### DETAILED DESCRIPTION

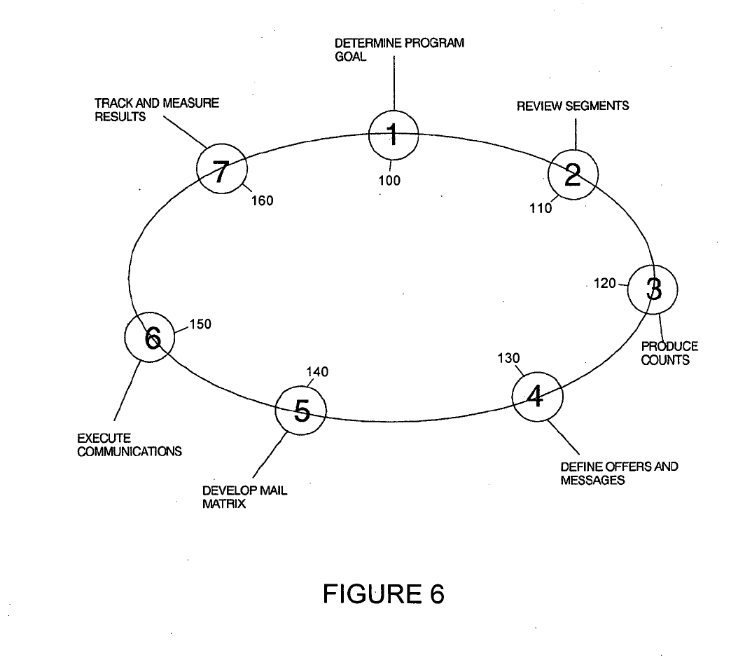

One aspect of the present invention is the realization that individuals better understand alternatives when marketing related to differing payment options is to them. Referring to FIG. 6, the market segmentation process provides for determining a program goal 100. In the embodiment, the program provides directed marketing to individuals who are receptive to the marketing being conducted, as well as offering these individuals the capability of additional financial transaction card features. Data is obtained from the financial transaction card issuer on the habits of use of the users of the financial transaction card. Segmentation of the data received is then performed. The segments are made and verified 110. Counts are produced 120 of individuals that may be migrated based upon the analysis conducted of the segmentation provided in step 110. After the counts are produced in step 120, offers and messages, for marketing 130 are generated for the individual segments that are defined in step 110 that are to be targeted. A mail matrix 140 is created such that marketing materials are distributed to only those segments of the data that have been determined to have a high likelihood of success. Instead of a mail matrix, other forms of advertising may be performed, such as when a customer uses a credit/debit card. After the mail matrix has been determined 140, communications are executed 150 to provide members of the segmented class with targeted communications. Lastly, results may be tracked and measured 160 for the effectiveness. Each of the blocks within the process will be discussed hereinafter.

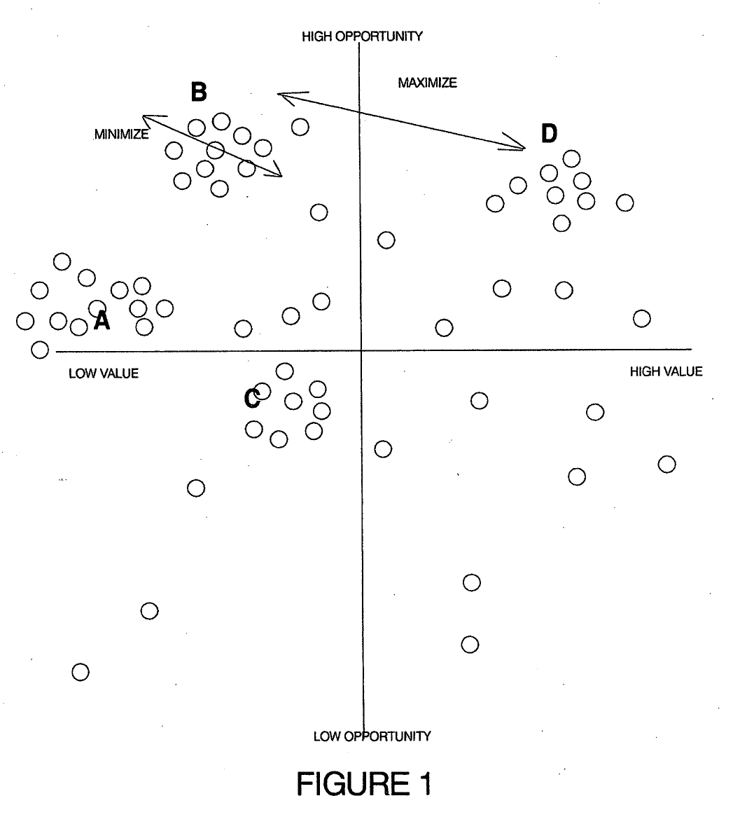

Referring to FIG. 1, a data set for financial transaction card users is presented. As provided above, the data set is obtained from individual card users and is related to individual user habits. The data, such as if a greater profit may be made off of a specific individual or if the user is a high value customer, is then placed in a graph characterized by the characteristics provided (in this instance opportunity and value). Data from use of Automated Teller Machines (ATM's), as well as cash advances are obtained for each user, for example. The data obtained, when separated, processed and graphed, indicates that users tend to act in similar patterns that allow for these similar users to be grouped together for purposes of effective marketing and/or use of new financial tool products. To this end, some users will not be prone to use new products or respond to marketing, or these users do not use financial transaction cards sufficiently to provide significant benefit for the financial transaction card issuer. Limited resources for marketing or testing products would not be beneficially spent on these individuals as little to no financial return is likely.

Conversely, members of certain groups are much more likely to respond to targeted advertising and as such, these groups provide more attractive capabilities to respond to marketing materials and to use new financial transaction card products. Resources for marketing or testing products would likely be beneficially spent on these individuals as there is a greater likelihood for a more significant financial return.

In the data provided in FIG. 1, opportunity values range from a low opportunity value to a high opportunity value in the Y abscissa. The X abscissa values range from a low value transaction capability on the left side to a high-value transaction capability on the right side. In the embodiment data provided in FIG. 1, the data is grouped into sections for analysis. In the embodiment provided, a subset of data is provided with a designation of A, wherein members of the group have a low value transaction capability. In addition to the low value transaction capability, these individuals have a medium opportunity capability. In data set A, the opportunity to migrate individuals from the low value designation to a high value rank is generally not available and therefore attempting to convert customers from their usage plans for financial transaction cards in data set A would have only a medium opportunity capability and would be a low financial value.

For individuals in data set C, a similar situation exists to those members of data set A. Those individuals in data set C have a medium opportunity capability, but have a slightly greater value to the financial transaction card company as their transactions are more profitable. Due to the limited number of individuals in data set C, however, attempted marketing to individuals in this data set would provide for limited results as the overall number of individuals within the data set is low and the opportunity level is. only of a medium level. Individuals within data set B, however represent a relatively high opportunity capability for receiving and using new technologies and/or methods of payment for financial transactions. The individuals in data set B, however, have a relatively low value capability as compared to that of data set D, that exhibits a high value. It would therefore be advantageous to try to minimize individuals within data set B and convert those individuals within data set B into individuals within data set D, that have a higher value and high opportunity capability. Individuals within data set B should be migrated to data set D, if possible, in order to maximize value. Migration of individuals within the appropriate data sets provided above will both allow users within these groups to obtain marketing materials related to new financial transaction card tools, methods of payment and other capabilities, while minimizing the costs spent by the financial transaction card issuer.

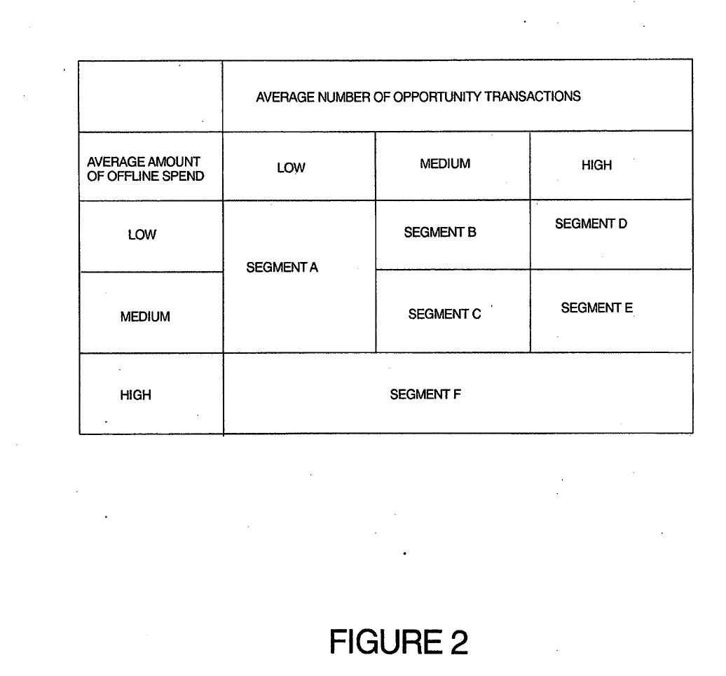

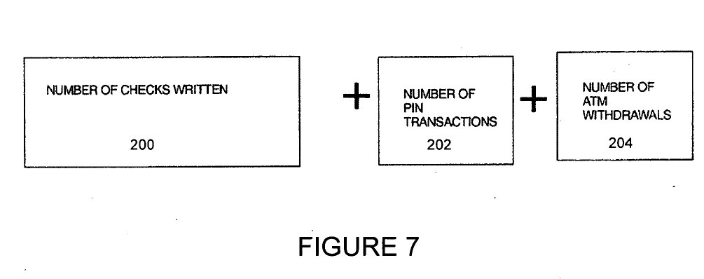

In order to identify individuals within groups as provided above, referring to FIG. 2, an segmentation matrix using average number of opportunity transactions and average amount of offline spending is provided. Individual threshold values for low, medium and high average number of transactions and average amount of offline spending are defined. Data sets for individuals may be characterized by the differing characteristics presented within the matrix. Different characterizing factors may be used and the illustrated embodiment is but one possibility. A user may define the average amount of offline spending in order to segment the data, as needed. Similarly, the average number of opportunity transactions may be selectable by a user into a low, medium and high value. An opportunity transaction is defined in FIG. 7.

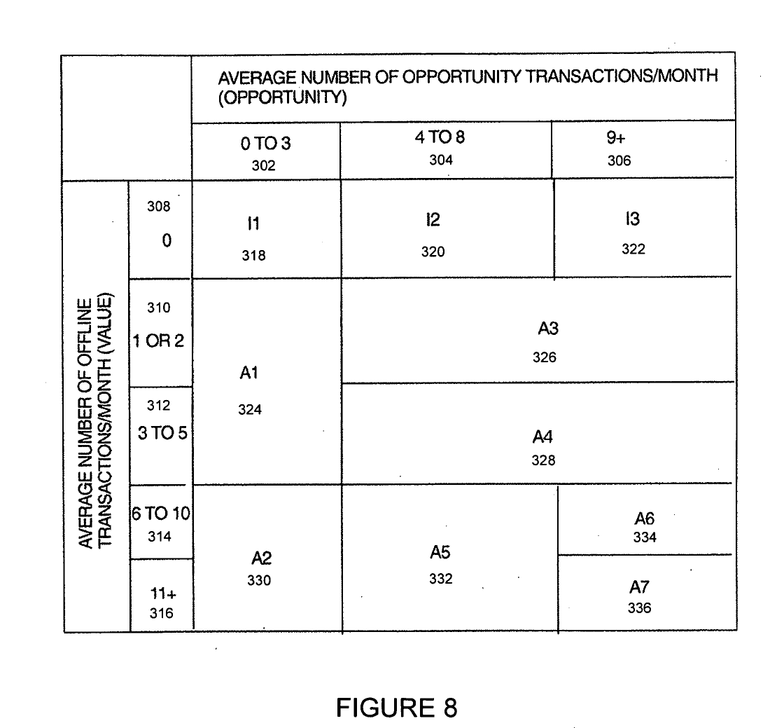

Referring to FIG. 8 an audience definition matrix is provided. This matrix is used to segment data of financial card users, as illustrated in FIG. 2. In the embodiment provided, the average number of opportunity transactions per month (opportunity) are separated into segments, ranging from 0 to 3 302 , 4 to 8 304 and 9 or greater 306. Although listed as providing the segments according to the divisions provided above, other designations may be performed. The average number of offline transactions per month. (value) is also used for segmentation. For use in the embodiment, the transactions may range from a low of zero 308, a second category of 1 or 2 310, a third category of 3 to 5 312, a fourth category of 6 to 10 314 and a fifth category of 11 or greater 316. The confluence 318 of the opportunity section of 0 to 3 and value section of 0 is provided with a designation I1. The confluence 320 of the opportunity section of 4 to 8 and value section of 0 is provided with a designation I2. The confluence 322 of the opportunity section of 9+ and value section of 0 is provided with a designation I3. The confluence 324 of the opportunity section of 0 to 3 and value section of 1 or 2 and 3 to 5 is provided with a designation A1. The confluence 326 of the opportunity section of 4 to 8 and 9+ and value section of 1 to 2 is provided with a designation A3. The confluence 328 of the opportunity section of 4 to 8 and 9+ and value section of 3 to 5 is provided with a designation A4. The confluence 330 of the opportunity section of 0 to 3 and value section of 6 to 10 and 11+ is provided with a designation A2. The confluence 332 of the opportunity section of 4 to 8 and value section of 6 to 10 and 11+ is provided with a designation A5. The confluence 334 of the opportunity section of 9+ and value section of 6 to 10 is provided with a designation A6. The confluence 336 of the opportunity section of 9+ and value section of 11+ is provided with a designation A7. Designators I1, I2 and I3 are all inactive type accounts that are not pursued due to lack of activity.

In the illustrated embodiment provided, designation A1 is defined as a low/medium value and no/low opportunity for migration. Designation A2 is defined as a high/best value and no/low opportunity for migration. Designation A3 is defined as a low value and medium/high opportunity for migration. Designation A4 is defined as a medium value and medium/high opportunity for migration. Designation A5 is defined as a high/best value and medium opportunity for migration. Designation A6 is defined as a high value and high opportunity for migration. Designation A7 is defined as a best value and high opportunity for migration. The total audience is then segmented into the individual audiences, as defined by the variables I1, I2, I3 and A1 to A7.

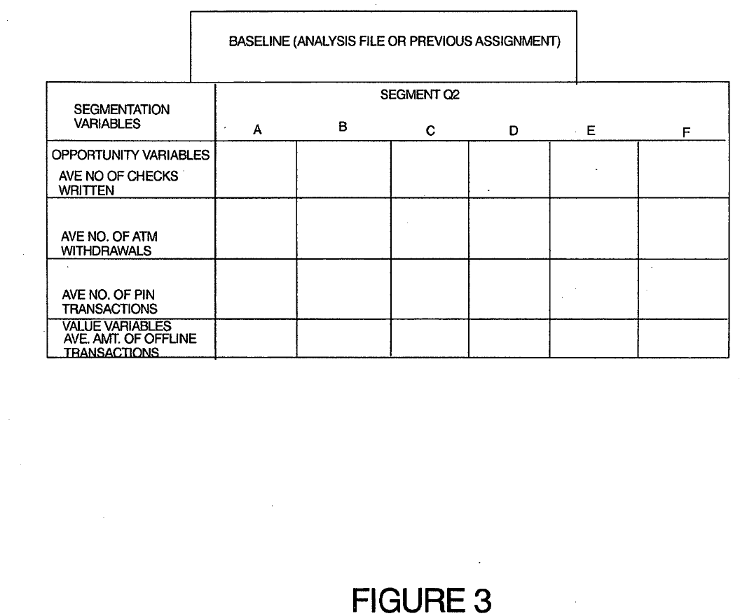

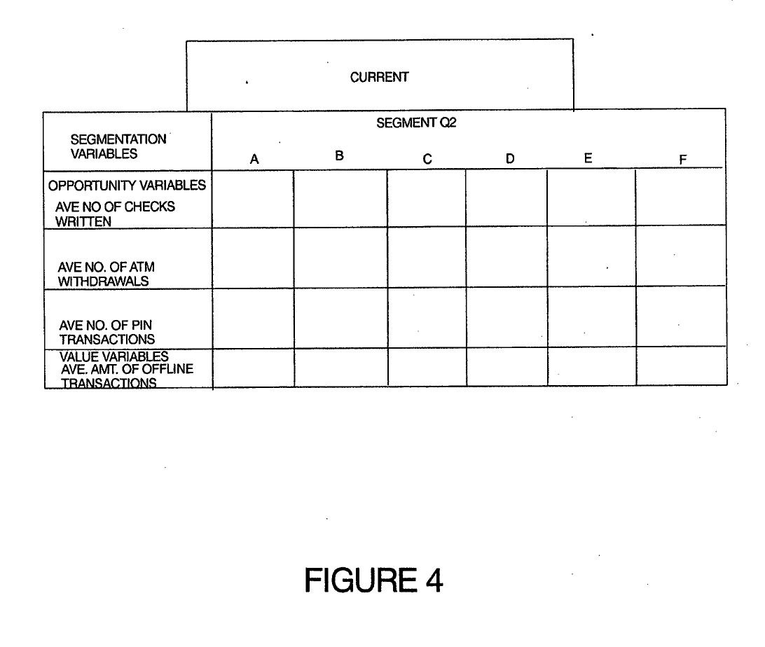

Referring to FIG. 3, verification 110 for the segmentation provided in FIG. 8, is presented to ensure that the segmentation properly defines audiences that will be targeted. In FIG. 3, a baseline analysis for historical data from financial transaction card users is presented. The baseline analysis that is conducted is provided with segmentation variables, herein provided designations A, B, C, D, E and F. In the left column, the number of opportunity variables is provided, including the average number of checks written by an user, the average number of automated teller machine withdrawals from an account is provided and the average number of PIN transactions and value variables with an average amount of offline transactions. Historical data is populated into the characterization matrix for comparison to FIG. 4, provided hereafter. A mean variable distribution of is performed upon the baseline case to determine the distribution of the data.

Referring to FIG. 4, data that is current (active) for financial transaction card owners is placed within this segmentation matrix. The data used in FIG. 4 is for active (current) status, as compared to historical data. As provided above in FIG. 3, segmentation variables A, B, C, D, E and F are provided. Opportunity variables are also designated with an average number of checks written, an average number of automated teller machine withdrawals, and average number of PIN transactions for an account and value variables of an average amount of offline transactions. A mean variable distribution is performed upon the current case data to determine the distribution of the data.

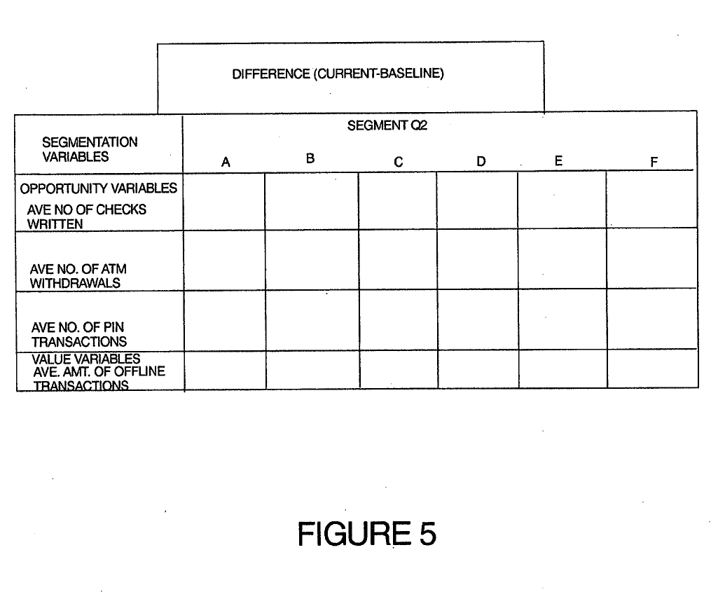

Referring to FIG. 5, a segmentation matrix is further provided that enables segmentation of data that is obtained, in the embodiment, from financial transaction card users. The segmentation matrix provided in FIG. 5 is a difference of the current (active) data provided in FIG. 4 and the data provided in FIG. 3, baseline analysis. A mean variable distribution is performed upon the difference to determine the distribution of the data, for example. The purpose of the difference matrix is to identify large changes in audience population over time.

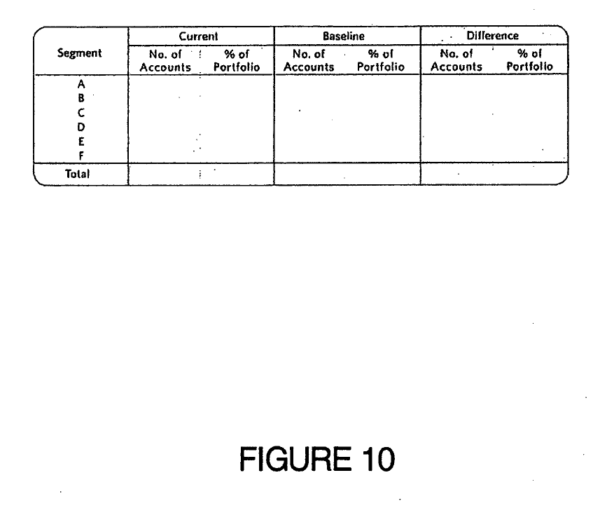

Referring to FIG. 7, an opportunity identification transaction for opportunity segmentation is defined. A number of checks written 200 (minus the number of checks that cannot be migrated) is added with the number of PIN transactions 202 and the number of ATM withdrawals 204. This value provides the number of opportunity transactions for each individual customer that may be part of an audience. The number of opportunity transactions is then used to determine the audiences used in the matrices. After the audience has been characterized as provided in the matrices, the audience is validated by looking at the audience distribution. As provided in FIG. 10, a verification of the segmentation of the audience is performed according to the number of accounts affected, and the percentage of the portfolio for current, baseline values. A difference is calculated between the current and baseline values.

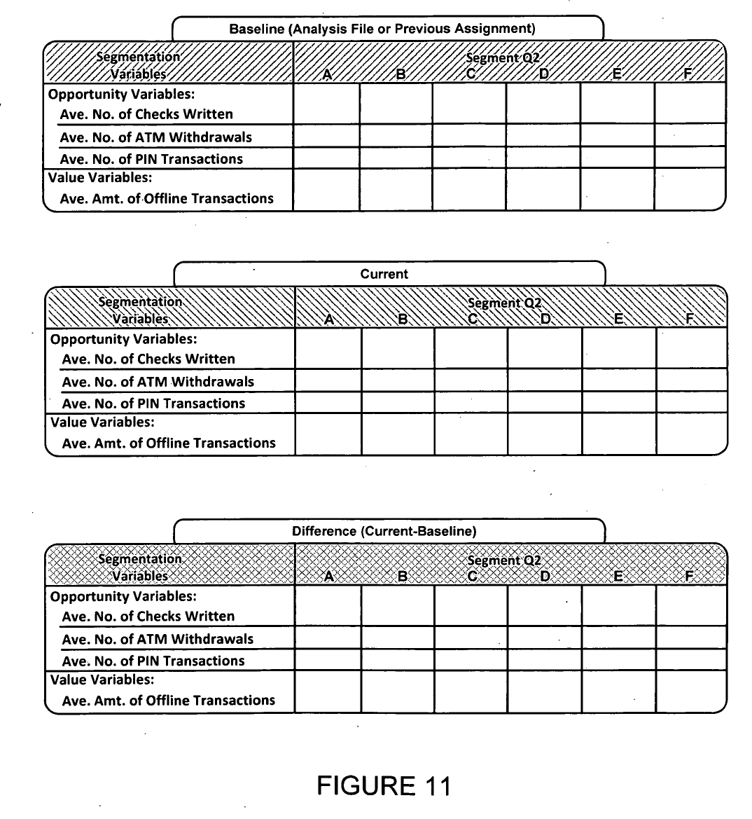

Referring to FIG. 11, validation may also be performed for each segmented variable A through F using a mean variable distribution technique. After review of the segmented mean variable distributions, individual segments may be targeted for promotional considerations that will provide for maximized returns. Such promotions may include providing suggestions for using card features more effectively during transactions, as a non-limiting example.

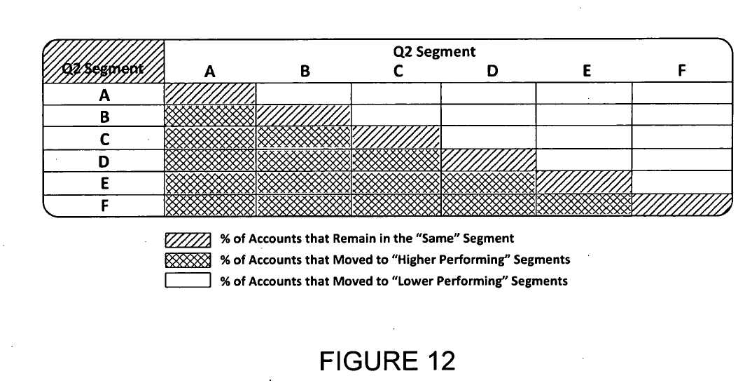

After promotion has taken place, a second round of data analysis may be conducted, wherein the actual audience migrated as a result of the promotions may be provided. Referring to FIG. 12, a report may be generated that indicates whether any/each of the segments has been moved from a given segment to another as a result of the promotional efforts.

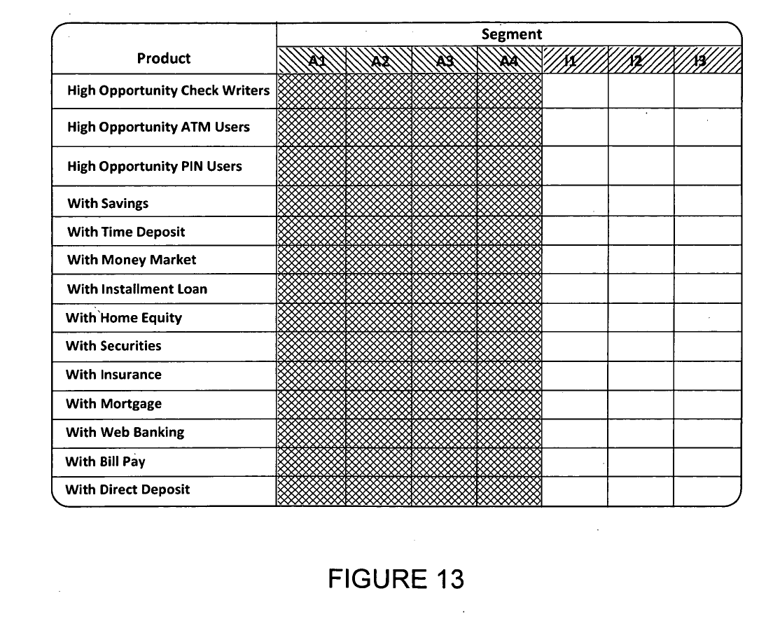

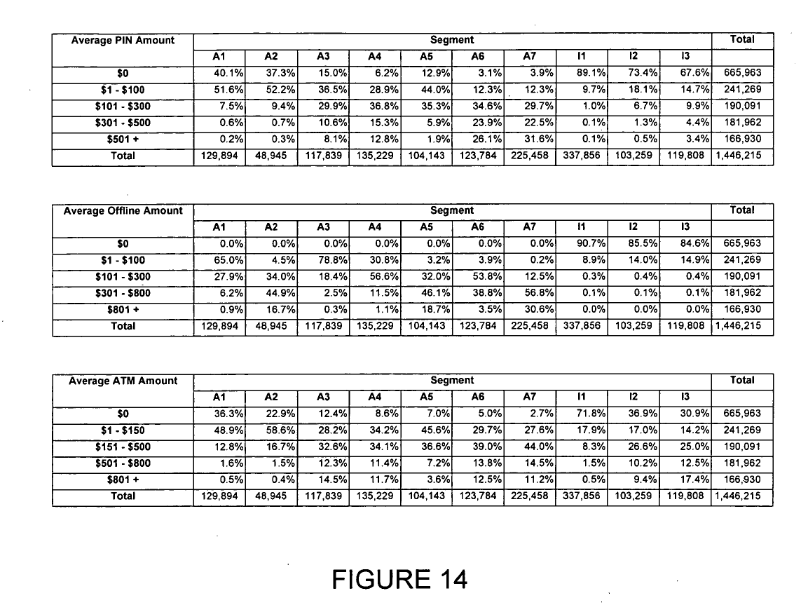

Additional “counts” may also be performed on the types of segments that were moved, based upon opportunity ratings, or according to the type of promotion conducted, referring to FIG. 13. Counts may also be performed prior to direct marketing activities. In the illustrated embodiment provided in FIG. 14, promotional activities related to money market accounts, installment loans, insurance and mortgages are defined. Review of the data may indicate that the amount of people receiving promotional materials related to mortgages may be more attractive than other promotional materials, therefore additional efforts related to this group may prove beneficial.

Promotional effectiveness may also be reviewed using other factors, such as, amounts requested as a result of PIN withdrawals, offline withdrawals and ATM account activities, as provided in FIG. 13.

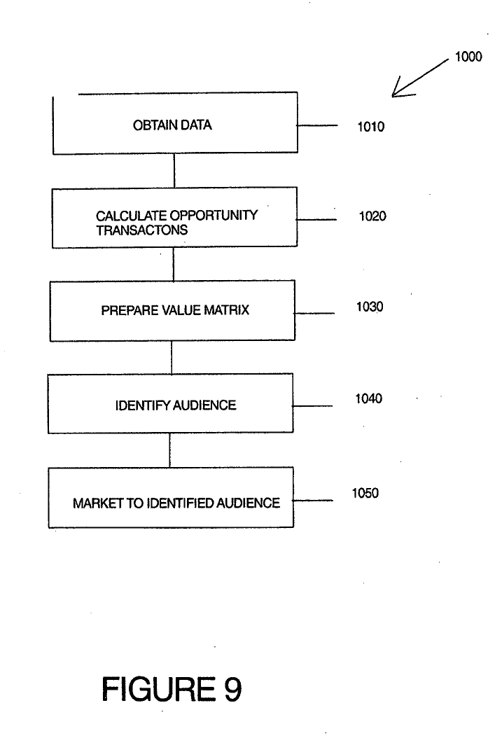

Referring to FIG. 9, a method to identify financial opportunity within a set of data, and maximize financial gains from the data set while minimizing marketing costs is provided, using, for example, the above components. In the method provided 1000, obtaining the set of data, the set of data including a value component and an opportunity component 1010 and calculating a number of opportunity transactions 1020.

In the method, the next step provides for creating a value matrix for value components and opportunity components of the set of data to define at least two audiences 1030 and identifying at least one audience of the at least two audiences that has a larger opportunity component than a smaller opportunity component of another of the at least two audiences 1040. Lastly, the method provides for marketing to the at least one of the at least two audiences that has the larger opportunity component 1050.

FIG. 14 presents a matrix of segments that were moved based upon the defined audience as broken down by PIN amount transactions, average off line transaction amounts and average ATM transaction amounts based upon the segmentation process.

### Sample Calculations

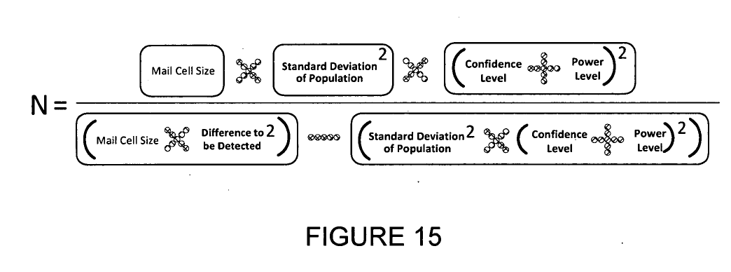

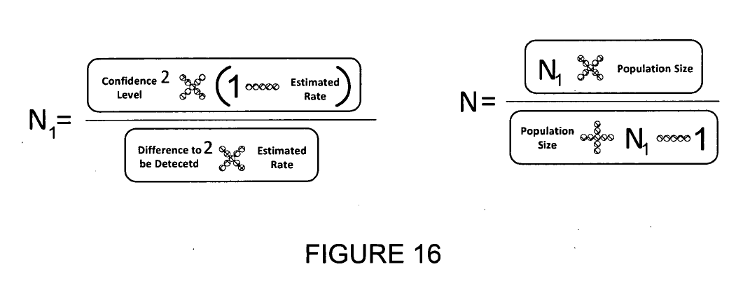

Referring to FIGS. 15 and 16, a set of calculations is to be performed to determine if a mailing to existing clients is warranted based upon available data of users, hereinafter called a “no mail” calculation. In FIG. 15, a standard deviation of the population to be sampled is attained. This number is provided for each segment. The value of the difference to be detected is the maximum acceptable difference between mail and no mail cells of average spend or average number of transactions. For example, if a mail cell has an incremental spending of $10 and it is desired to accept a 0.5 difference, then the incremental spend of less than $9.50 is greater than $10.50 would be statistically different. The confidence level is defined as the sample results wherein 95% confidence means that on a sample of 100 cardholders the same result would be achieved for 95 of the 100 tested. The mail cell size is the size of the population to be mailed in a test. Lastly, the power level is defined as the lower the probability of missing an actual difference between two groups. For example, 90% power means there is only a 10% chance of missing an actual difference between the mail and the no mail group.

Using values of:
Standard deviation=100
Confidence level=95% or 1.96
Power Level=90% or 1.282
Difference Detected=5
Mail cell size=50,000
The value for N=4,590.
For a calculation of enrollment rate, referring to FIG. 16, inputs necessary to complete the calculation include:
Population Size—Count of cardholders in population to be sampled.
Estimated Rate—The expected response or enroll rate for the population to be sampled.
Difference to be Detected—The maximum acceptable percent difference between the mail and no mail cells. For example, if the mail cell has an enroll rate of 2% and you are willing to accept a 10% difference, then an enroll rate of 1.8% to 2.2% would not be considered statistically different.
Confidence Level—Level of confidence that the results from the sample results are accurate.
Using a 10% difference in enrollment rate to 100,000 cardholders and using a difference wherein historical response to the population was 2% with a 90% confidence level, N₁=13,260
Since N₁=13,260 and is greater than 5% of 10,000 then N is calculated as 11,707.

In the foregoing specification, the invention has been described with reference to specific embodiments thereof. It will, however, be evident that various modifications and changes may be made thereunto without departing from the broader spirit and scope of the invention as set forth in the appended claims. The specification and drawings are accordingly to be regarded in an illustrative rather than in a restrictive sense.

What is claimed is:

1. A method to identify financial opportunity within a set of data, and maximize financial gains from the data set while minimizing marketing costs, comprising:
obtaining the set of data, the set of data including a value component and an opportunity component;
calculating a number of opportunity transactions;
creating a value matrix for the value components and the opportunity components of the set of data to define at least two audiences;
identifying at least one audience of the at least two audiences that has a larger opportunity component than a smaller opportunity component of another of the at least two audiences;
migrating the at least one audience of the at least two audiences that has a larger opportunity component than a smaller opportunity component of another of the at least two audiences to a higher value opportunity;
tracking the value components and the opportunity components of all audiences; and
marketing to the at least one of the at least two audiences that has the larger opportunity component.

2. The method according to claim 1, wherein the calculation of the number of opportunity transactions includes adding a number of checks written by an individual with a number of PIN transactions and a number of ATM withdrawals.

3. The method according to claim 1, wherein the value component of the set is calculated from a number of financial signature transactions completed by an individual.

4. The method according to claim 1, wherein the opportunity component of the set is calculated from transactions that have a possibility of migration from a lower financial gain to a higher financial gain.

5. The method according to claim 1, wherein the set of data is derived from financial transaction card users.

6. The method according to claim 1, wherein the calculation of the number of opportunity transactions includes adding a number of checks written by an individual with a number of PIN transactions and a number of ATM withdrawals minus a number of checks written that cannot be migrated.

7. The method according to claim 1, wherein the identifying at least one audience of the at least two audiences that has a larger opportunity component than a smaller opportunity component of another of the at least two audiences is performed through dividing the data into a matrix defined by an average number of offline transactions per month and an average number of opportunity transactions per month.

8. The method according to claim 7, further comprising:
validating the audiences of the defined matrix.

9. The method according to claim 8, wherein the validating of the audiences uses a mean variable distribution of the data.

10. A computer-readable medium encoded with data and instructions, when executed by a computer configured to identify financial opportunity within a set of data, and maximize financial gains from the data set while minimizing marketing costs, the instructions causing the computer to:
obtain the set of data, the set of data including a value component and an opportunity component;
calculate a number of opportunity transactions;
create a value matrix for the value components and the opportunity components of the set of data to define at least two audiences;
identify at least one audience of the at least two audiences that has a larger opportunity component than a smaller opportunity component of another of the at least two audiences;
migrate the at least one audience of the at least two audiences that has a larger opportunity component than a smaller opportunity component of another of the at least two audiences to a higher value opportunity;
track the value components and the opportunity components of all audiences; and
market to the at least one of the at least two audiences that has the larger opportunity component.

11. The computer-readable medium according to claim 10, wherein the calculation of the number of opportunity transactions includes adding a number of checks written by an individual with a number of PIN transactions and a number of ATM withdrawals.

12. The computer-readable medium according to claim 10, wherein the value component of the set is calculated from a number of financial signature transactions completed by an individual.

13. The computer-readable medium according to claim 10, wherein the opportunity component of the set is calculated from transactions that have a possibility of migration from a lower financial gain to a higher financial gain.

14. The computer-readable medium according to claim 10, wherein the set of data is derived from financial transaction card users.

15. The computer-readable medium according to claim 10, wherein the calculation of the number of opportunity transactions includes adding a number of checks written by an individual with a number of PIN transactions and a number of ATM withdrawals minus a number of checks written that cannot be migrated.

16. The computer-readable medium according to claim 10, wherein the identifying at least one audience of the at least two audiences that has a larger opportunity component than a smaller opportunity component of another of the at least two audiences is performed through dividing the data into a matrix defined by an average number of offline transactions per month and an average number of opportunity transactions per month.

17. The computer-readable medium according to claim 16, further comprising:
validating the audiences of the defined matrix.

18. The computer-readable medium according to claim 17, wherein the validating of the audiences uses a mean variable distribution of the data.
